(19) United States
(12) Patent Application Publication
(10) Pub. No.: US 2003/0236736 A1
(43) Pub. Date: Dec. 25, 2003

(54) Electronic system and method for trading seat licenses, event tickets and contingent event ticket certificates

(76) Inventors: Richard Harmon, Lake Forest, IL (US); Herbert Rudoy, Chicago, IL (US); Jerold Siegan, Chicago, IL (US)

Correspondence Address: Bell, Boyd & Lloyd LLC, P.O. Box 1135, Chicago, IL, 60690-1135, US

(21) Appl. No.: 10/179,634

(22) Filed: Jun. 25, 2002

(51) Int. Cl. G06F 17/60

(52) U.S. Cl. 705/37

(57) ABSTRACT

An electronic exchange and a method for trading a seat license, tickets and contingent event ticket certificates for events at certain venues and for events which may be or may not be scheduled in the future to take place at the venue are provided. The seat licenses and season tickets grant the licensee or holder the right and in some cases the obligation to purchase tickets and the contingent event ticket certificates. Contingent event ticket certificates convert to event tickets at a time associated with the actual scheduling of the contingent event, when the contingent event ticket certificate converts the holder of the contingent event ticket certificate is charged the face value of the ticket. The exchange and method provide for trading in seat licenses, tickets and contingent event ticket certificates between a number of buyers and sellers.

### BACKGROUND OF THE INVENTION

The present invention relates to an electronic exchange and method for trading permanent seat licenses, event tickets, and contingent event ticket certificates. The exchange and method of the present invention may be applied to any number of events, or series of events taking place at a venue such as a sports stadium or theater. Typically, tickets for sporting events, concerts, theatrical performances, and the like, are sold to the public in advance of the event at a predetermined face value. Often, however, the face value of a ticket does not accurately reflect the true value of the ticket. Namely, the face value of the ticket does not reflect the actual price people are willing to pay to attend the event. For high demand events, such as the Super Bowl, World Series or other championship and playoff games, or concerts by popular entertainers, fans are often willing to spend many times the face value of a ticket in order to attend the event.

This excess demand has created a large secondary market for major event tickets. Often ticket “scalpers,” brokers, and other speculators will purchase large blocks of tickets at face value and resell the tickets at whatever price the secondary market will bear. Often at considerable profit. Even fans who are not in the business of profiting from inflated ticket prices will sometimes “cash in” if the ticket resale price is driven so high that it exceeds their interest in attending the event. It should be noted, however, that individuals who do not regularly participate in this secondary market have a more difficult time determining the market value of tickets they are trying to purchase, or trying to sell. It will often take many contacts with several brokers, scalpers, or other individuals to determine the going rate for event tickets. In some cases ticket holders who wish to sell their tickets must actually travel to the event venue itself in hopes of connecting with others who have also come to the venue in hopes of purchasing tickets. This method of making a market is time consuming and inefficient.

In addition to the inefficiencies of such an unsanctioned, organically developed secondary market, the very existence of such a market represents lost revenue to the parties responsible for producing the event, namely the team owners, the leagues, promoters, producers, and the like (collectively the event producer or event producers). When a fan pays $500.00 to a scalper for a ticket having a $120.00 face value the fan pays an additional $380 for the producer's product. The producer sees none of this additional value. Obviously, it is in the producer's interest to realize at least a portion of the additional value of tickets for high demand events, either by more appropriately setting the face value of the tickets, or by in somehow participating in the secondary market.

In addition to individual event tickets, event producers will often sell tickets in a package for a series of related events. For example, sports team owners sell season ticket packages. Symphonies and opera companies offer patrons subscription series to their season's performances. Such ticket packages include individual event tickets for some or all of the events the team or performance company will perform at their home venue, be it a ball park, theater, concert hall or the like. Typically the individual tickets associated with such packages will be for the same seat within the venue for each event. A problem that sometimes arises for season ticket holders is that the ticket holder is unable to attend all of the individual events. In such cases the ticket holder is left holding a ticket that has no value to the ticket holder, but which may be highly coveted by another fan. The season ticket holder unable to use the ticket would obviously like to sell the unusable ticket to someone who can attend the event. Not only would the ticket holder like to sell the ticket to a fan desiring to attend the event, the ticket holder would like to sell the ticket to the fan most desirous of attending the event in order to receive the highest price possible. However, making the connection between the season ticket holder and that most desirous fan is no simple matter. Creating an accessible marketplace where ticket buyers and sellers can easily find one another would likely increase the value of season or series ticket packages since the purchasers of such packages would know that, in the event that some tickets are not used, the season ticket holder can easily sell the unusable tickets to recoup at least a portion of the cost of the package.

Another recent development that impacts the availability of tickets and the price of tickets in secondary ticket markets is the advent of the permanent seat license, or PSL. PSLs are generally an extension of the season ticket concept. They are most often sold in conjunction with efforts to raise money for the construction of new venues such as new sports stadiums, although they can be sold for existing venues as well. A typical PSL grants the licensee the right to purchase season tickets for a particular seat in the venue every season. The PSL may extend for a limited number of seasons, such as ten seasons, for example, or the PSL may continue in perpetuity. In some cases the licensee is obligated to purchase the season tickets each season depending on the conditions of the license.

Because the PSL allows and in some cases obligates the licensee to purchase season tickets each season, the same difficulties regarding unusable tickets within a season ticket package described above apply to PSLs. Thus, an accessible market for trading event tickets would benefit PSL licensees in the same manner as it would traditional season ticket holders, thereby increasing the value of PSLs. Because of the multi-season nature of PSLs, their appeal may be somewhat limited. For example, a PSL which obligates the licensee to purchase season tickets annually for 10 years may not appeal to a fan who likely will be required to move to another market in less than 10 years. If however, such a fan is allowed to sell the unexpired term of such a PSL when he or she leaves the area, the fan may be more likely to buy the PSL in the first place, knowing that he or she may be able to recover at least a portion of the cost of the PSL by selling the unexpired term. Thus, a market that allows trading in PSLs would also likely increase the value of PSLs.

A final aspect of the secondary ticket market that affects the profits realized by event producers is the demand for tickets to events that may (or may not) be scheduled in the future. The most common example of this is the market for sporting event playoff and championship games. At the beginning of a season a local team's prospects for making the end of season playoffs or of being in the championship game may not be too promising. Therefore, at the beginning of the season demand for playoff or championship game tickets will be low, since such games are unlikely ever to occur. If the team performs well during the course of the season, however, the chances that such playoff games, or a championship game with the local team participating may steadily increase. Thus, demand for potential playoff or championship game tickets will increase as well.

Various event producers handle the distribution of tickets for such contingent events in different ways. For example, some event producers will require PSL and season ticket holders to purchase contingent event tickets if and when the contingent events become a reality. Other event producers may grant PSL and season ticket holders a right of first refusal to purchase such tickets when the contingent event is scheduled. Finally, other event producers will sell tickets to the newly scheduled contingent events independently of the PSL and season ticket offerings. Regardless of the mechanism by which the contingent event tickets are offered to the public, the event producers can profit by somehow participating in the secondary ticket market. Further, for those event producers who associate the sale of contingent event tickets with season ticket packages and PSLs, providing a market for reselling contingent event tickets will help increase the value of the season ticket packages and the PSLs.

### SUMMARY OF THE INVENTION

The present invention relates to an exchange for trading permanent seat licenses, event tickets and contingent event ticket certificates as well as a method for trading permanent seat licenses, event tickets and contingent event tickets. In an embodiment of the invention inventory traded on the exchange is limited to PSLs and the event tickets associated with PSLs, as well as contingent event ticket certificates which may or may not be associated with PSLs. The exchange provides a mechanism whereby individuals holding inventory in the form of PSLs, event tickets or contingent event tickets may post offers to sell some or all of their holdings at a specified price. The exchange also provides a mechanism whereby individuals desiring to buy PSLs, event tickets or contingent event tickets may post bids to purchase specific items at a specified price. Such bids and offers are made available to all members of the exchange so that those interested in the specific inventory which is being offered for sale or which is being bid on can determine the market value of such inventory.

Those members of the exchange willing to buy inventory which has been offered for sale may accept an offer at the specified price, or may submit a bid below the offering price. Similarly, those individuals holding inventory corresponding to a submitted bid may except the bid and sell the inventory at the bid price. Alternatively, the inventory owner may submit an offer to sell at a price below the current bid price. The exchange matches offers and bids with indications of accepting the offers and bids, transfers the inventory between the buyer and seller, and charges the buyer an amount corresponding to the accepted offer or bid and credits the seller an amount corresponding to the accepted offer or bid. Thus, buyers and sellers need only deal with the exchange, not directly with one another.

An embodiment of the invention provided an electronic exchange for trading PSLs, event tickets and contingent event ticket certificates. The electronic exchange includes a web server accessible by an unlimited number of buyers and sellers over a network, the web server is adapted to provide an exchange interface to the buyers' and sellers' computer terminals over the network to be displayed by the buyers' and sellers' network browsers. The interface is configured to transmit user commands entered by the buyers and sellers to the exchange for submitting offer to sell inventory bids to purchase inventory as well as indications of acceptance offers to sell and bids to purchase inventory. A database maintains records of all members of the exchange as well as a record of all inventory traded on the exchange. A matching engine, which may or may not be running on the same platform as the web server matches the acceptance of offers to sell and bids to purchase inventory with the offers and bids themselves. The matching engine then initiates a transaction wherein ownership of the subject inventory is transferred from the seller to the buyer. This is accomplished by altering the inventory records stored in the data base. The matching engine further initiates a transaction wherein the buyer is charged an amount corresponding to the accepted bid or offer, and the seller is credited a similar amount.

The method of trading permanent seat licenses, event tickets and contingent event ticket certificates of the present invention includes the steps of receiving offers to sell such inventory as well as bids to purchase. Once such offers and bids are received they are communicated to the members of the exchange who are the potential buyers and sellers of the inventory specified in the various bids and offers received. The next step in the inventive method involves receiving corresponding indications that the bids and offers have been accepted by other members of the exchange. The corresponding indications of the acceptance of the bids and offer are matched to the respective bids and offers. A transaction is then initiated whereby ownership of the subject inventory is transferred from the seller to the buyer, the buyer is charged an amount related to the bid or offered amount, and the seller is credited a similar amount.

Additional features and advantages of the present invention are described in, and will be apparent from, the following Detailed Description of the Invention and the figures.

### BRIEF DESCRIPTION OF THE FIGURES

FIG. 1 is a flow chart of a method of trading PSLs, event tickets, and contingent event ticket certificates according to the present invention.

FIG. 2 is a plan view of a venue showing various seating zones.

FIG. 3 is a schematic block diagram of an exchange for trading PSLs, event tickets and contingent event ticket certificates according to an embodiment of the invention.

FIG. 4 is a block diagram of a network based exchange according to an embodiment of the invention.

FIG. 5 is a screen shot of a graphical user interface for an exchange according to an embodiment of the invention showing a login page.

FIG. 6. is a screen shot of a graphical user interface for an exchange according to an embodiment of the invention showing a customized customer page showing seat license holdings of a PSL owner.

FIG. 7. is a screen shot of a graphical user interface for an exchange according to an embodiment of the invention showing a customized customer page showing event ticket holdings of a PSL owner.

FIG. 8. is a screen shot of a graphical user interface for an exchange according to an embodiment of the invention showing a new order page.

FIG. 9. is a screen shot of a graphical user interface for an exchange according to an embodiment of the invention showing a customized customer page showing submitted orders.

FIG. 10 is a screen shot of a graphical user interface for an exchange according to an embodiment of the invention showing a customized customer page of a customer having no holdings.

FIG. 11 is a screen shot of a graphical user interface for an exchange according to an embodiment of the invention showing a purchase event tickets page.

FIG. 12 is a screen shot of a graphical user interface for an exchange according to an embodiment of the invention showing a more detailed purchase ticket page.

FIG. 13 is a screen shot of a graphical user interface for an exchange according to an embodiment of the invention showing a purchase event tickets invoice page.

FIG. 14 is a screen shot of a graphical user interface for an exchange according to an embodiment of the invention showing a customized customer page showing the event ticket holdings of an event ticket trader.

FIG. 15. is a screen shot of a graphical user interface for an exchange according to an embodiment of the invention showing a an event ticket purchase/sell event tickets page.

FIG. 16 is a screen shot of a graphical user interface for an exchange according to an embodiment of the invention showing a an event tickets sales invoice page.

FIG. 17 is a screen shot of a graphical user interface for an exchange according to an embodiment of the invention showing a bid acceptance message page.

FIG. 18 is a screen shot of a graphical user interface for an exchange according to an embodiment of the invention showing a customized customer page showing an event ticket purchaser's event ticket holdings.

FIG. 19 is a screen shot of a graphical user interface for an exchange according to an embodiment of the invention showing an event tickets transfer page.

FIG. 20 is a screen shot of a graphical user interface for an exchange according to an embodiment of the invention showing a ticket transfer e-mail message sent to an event ticket transferee.

FIG. 21 is a screen shot of a graphical user interface for an exchange according to an embodiment of the invention showing a customized customer page showing an event tickets transferee's ticket holdings.

FIG. 22 is a screen shot of a graphical user interface for an exchange according to an embodiment of the invention showing a screen shot of two event ticket coupons ready to be printed and used to gain access to the venue for the specified event.

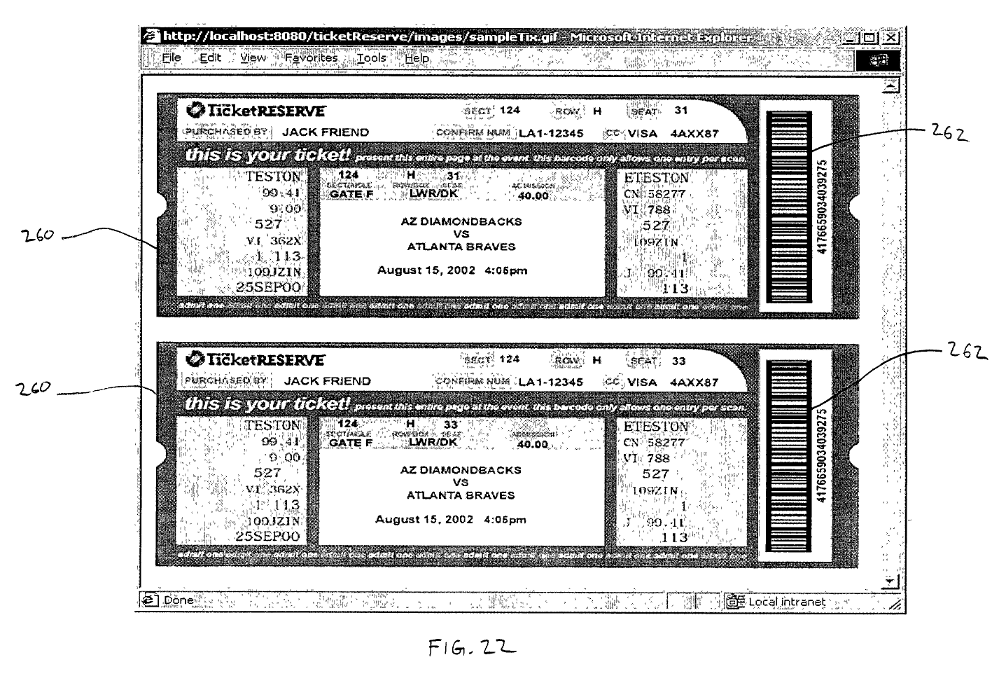

### DETAILED DESCRIPTION OF THE INVENTION

The present invention relates to a market for trading permanent seat licenses (PSLs), individual event tickets, and contingent event ticket certificates for various events, such as sporting events, concerts, and the like which are scheduled to take place, or may in the future be scheduled to take place at a designated venue. The invention provides both a method of trading such products and an electronic exchange for facilitating such trades.

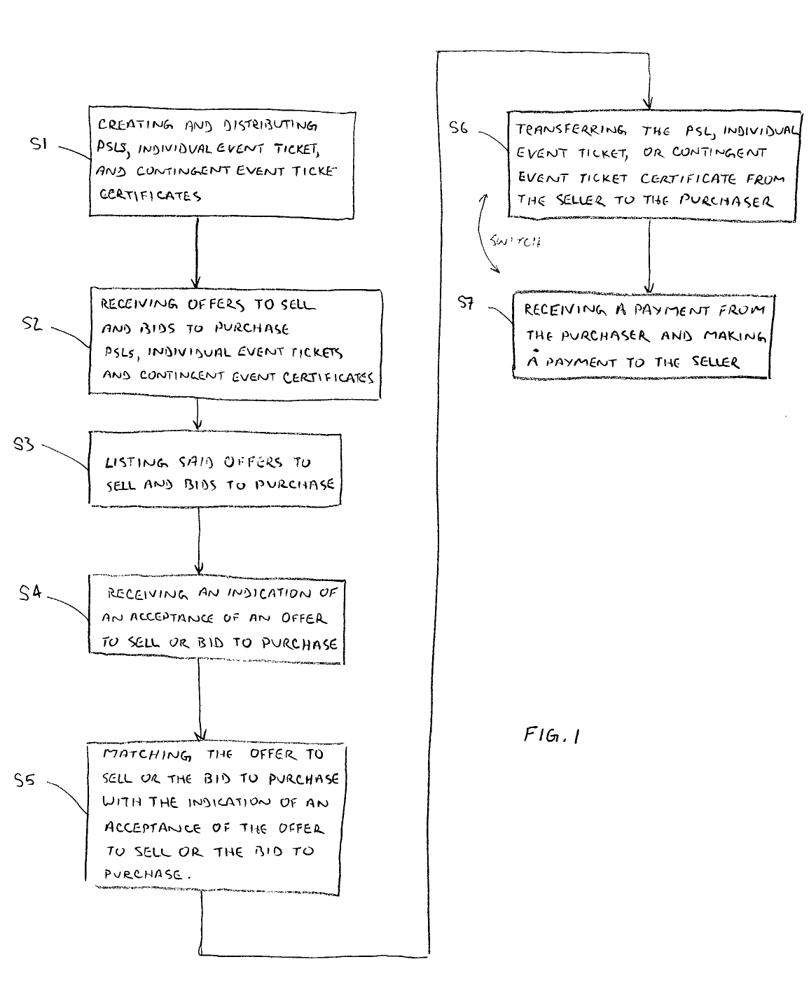

Referring first to FIG. 1, a method is disclosed for trading PSLs, event tickets and contingent event ticket certificates. Step S1 calls for creating and distributing an inventory of PSLs, individual event tickets, and contingent event ticket certificates. Contingent event tickets are a novel product created in accordance with the present invention. A contingent event ticket certificate represents the right and obligation to purchase an event ticket at face value for an event that may (or may not) be scheduled in the future. According to an embodiment of the invention, whoever is the holder of record of a contingent event ticket certificate when the contingent event is scheduled and tickets for the event go on sale is automatically billed for the face value of the ticket. If the contingent event ticket certificate holder has agreed to pay by credit card, the designated credit card account is automatically charged. In order to facilitate electronic trading of PSLs, event tickets, and contingent event ticket certificates, it is preferred that the initial distribution of tickets and contingent event ticket certificates is performed electronically so that a database may be maintained of all tickets and contingent event ticket certificates in the inventory, the current owner of each ticket or contingent event ticket certificate, and an audit trail of all previous owners going back to the ticket's or contingent event ticket's creation. Also in the interest of facilitating electronic trading of PSLs, event tickets and contingent event ticket certificates and maintaining accurate ownership records of such products, it is further preferred that only tickets associated with PSLs are traded on the exchange.

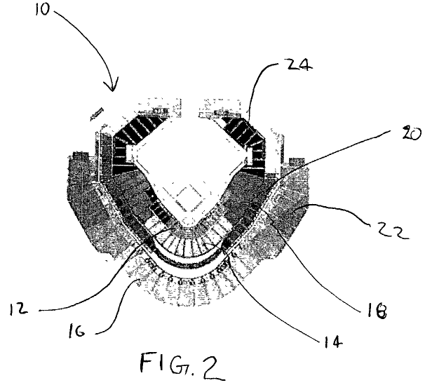

Since each PSL, ticket, and contingent event ticket certificate corresponds to a particular seat within a venue, it is possible to group PSLs, tickets, and contingent event certificates into zones or sections having similar viewing characteristics. For example, referring briefly to FIG. 2, a diagram of a baseball park is shown at 10. The seating areas around the ball park are divided into a patchwork of differently shaded zones. A first zone 12 is shown in the box seat area behind and around home plate. Terrace box seats behind zone 12 form a second zone 14, while a third zone 16 includes the upper deck seats behind home plate. Additional zones 18, 20 and 22 are established in the box, terrace box and upper deck areas respectively along the first and third base lines, and a final zone 24 is established in the bleacher sections and behind the visiting team's dugout. According to the preferred embodiment of the invention seats within the same zone are considered fungible. A person using the present inventive method or electronic exchange to purchase a ticket must specify a zone in which he or she wishes to purchase a ticket. A ticket for any seat within the specified zone will satisfy a purchase request for a ticket within the specified zone.

Returning to FIG. 1, once the PSL, ticket, and contingent event ticket certificate inventory has been distributed, step S2 involves receiving offers to sell and bids to purchase PSLs, event tickets and contingent event ticket certificates. In an embodiment of the invention transactions are settled in real time. Only the actual holders of inventory (PSLs, tickets, and contingent event ticket certificates) can place offers for sale, while any member of the exchange can place bids to purchase. However, other trading rules are possible where a party not holding inventory may be allowed to offer PSLs, tickets or contingent event ticket certificates for sale as long as he or she makes good delivery of the sold products at a specified time and in a specified manner.

Step S3 calls for listing the received offers to sell and bids to purchase inventory. In order to limit confusion and increase the efficiency of the market, not every offer and bid need be displayed. For example, the current market rate for PSLs, tickets or contingent event ticket certificates may be quickly surmised from the best bid and best offer for a particular zone. The most recent transaction for a PSL, ticket or contingent ticket in a given zone may also give further guidance as to the current market price.

Step S4 involves receiving an indication either from a purchaser indicating that he or she accepts one of the listed offers to sell, or from a seller indicating that he or she accepts one of the listed bids to purchase. The party who posted the accepted bid or offer is matched to the party who indicated an acceptance of the bid or offer in step S5. A payment is received from the purchaser and a payment is made to the seller in step S6. Finally, the inventory that is the subject of the transaction, be it a PSL, an individual event ticket (or tickets), or a contingent event ticket certificate (or certificates), is transferred from the seller to the purchaser.

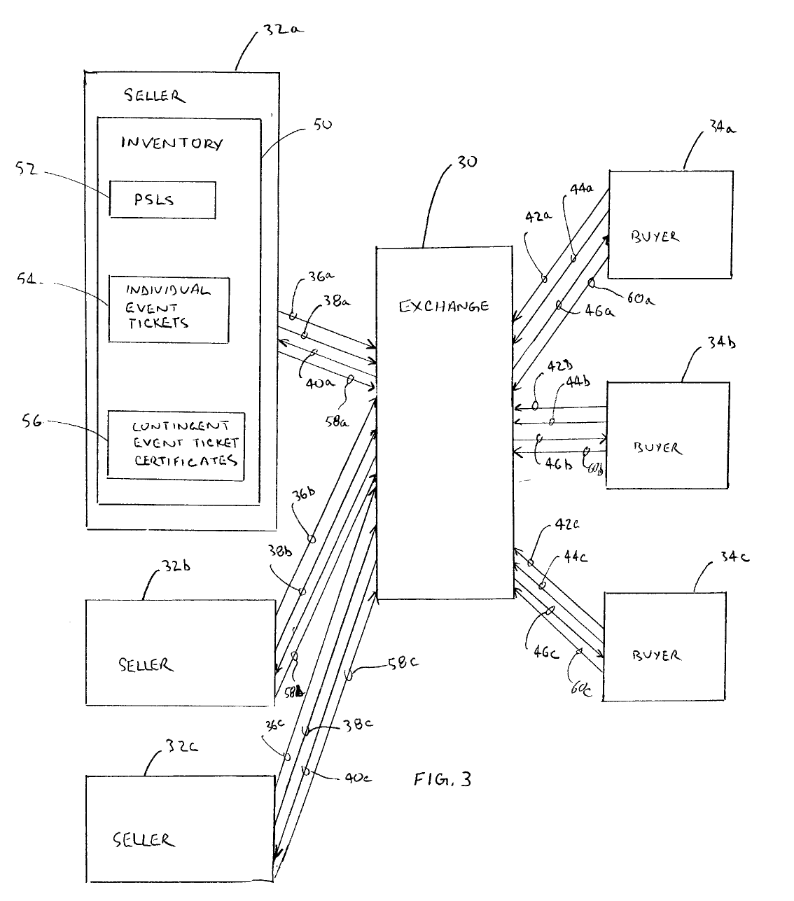

In addition to the method of trading PSLs, individual event tickets, and contingent event tickets just described, the present invention further encompasses an exchange for trading PSLs, event tickets and contingent event ticket certificates according to the method just described. Such an exchange is shown schematically in FIG. 3. A primary function of the exchange 30 is to list offers to sell and bids to purchase inventory, match the parties making bids and offers with the parties accepting the bids and offers, and exchange the inventory and payment therefor between the buyers and sellers. Thus, a plurality of sellers 32a, 32b, 32c figuratively “bring” their inventory 48 to the exchange. Three sellers and three buyers are depicted in FIG. 3, however, in reality any number of buyers and sellers may access the exchange 30. A seller's inventory 48 may include one or more each of PSLs 50 individual event tickets 52 and contingent event ticket certificates 54. The sellers 32a, 32b, 32c may list offers to sell items of their inventory on the exchange 30 as indicated by the arrows 36a, 36b, 36c. Typically, such listings would include a description of the inventory item and the offering price. For example, the seller 32a may list four individual event tickets in zone 18 (see FIG. 2) for sale for a August 10 double header between Team A and the Team B for $40.00 each.

Buyers 34a, 34b, 34c approach the exchange with no inventory but with cash in hand to make purchases. The buyers 34a, 34b, 34c may post bids to purchase inventory on the exchange, as indicated by arrows 42a, 42b, 42c. Typically such a posting would include a description of the inventory the buyer wishes to purchase and the amount the buyer is offering to pay. For example, buyer 34a may post a bid for four zone 18 tickets (see FIG. 2) for the same August 10 doubleheader described above, offering to pay $20.00 per ticket. The seller 32a 's offer to sell the tickets at $40.00 and the buyer 34a's bid to purchase the tickets at $20.00 are listed on the exchange and are visible to all participants in the exchange, both buyer and sellers. Thus, a market price is established somewhere between $20.00 and $40.00 per ticket for a set of four tickets in zone 18 for the August 10 double header between Team A and Team B.

In addition to listing their inventory for sale at a specific price above the current market price, sellers may alternatively chose to accept a buyers' bid to purchase tickets at the buyer's bid price. Such a transaction is indicated by arrows 38a, 38b, 38c. So, for example, if seller 32a sees buyer 34a's $20.00 bid and decides that it is close enough to what he or she willing to accept for the tickets, seller 32a may accept the offer. Of course, seller 32b, or 32c who may also have inventory equivalent to that being offered by seller 32a (i.e., four tickets in zone 18 for the August 10 doubleheader between Team A and Team B), may under cut the first seller's 32a original $40.00 offering price by either offering to sell their inventory at a lower price, or by accepting a buyer's lower bid price.

A similar process is at work on the buyers side of the exchange. Buyers may place bids to purchase tickets at prices below those currently offered by the sellers, or buyers may accept sellers listed offers. Such transactions are indicated by arrows 44a, 44b, 44c. If buyer 34a sees seller 32a 's $40.00 per ticket offer and decides that her or she is willing to pay that amount to attend the event, buyer 34a may accept seller 32a 's offer. Of course, buyers 34b or 34c may also want to attend the August 10 doubleheader and beat buyer 34a to the punch by either accepting seller 32a's $40.00 per ticket offer, or by posting a bid for four zone 18 tickets at a price higher than the $20.00 per ticket offered by buyer 34a.

Once an offer or bid is accepted the exchange matches the buyer with the seller. Preferably this function is transparent to the parties using the exchange. The buyer and seller deal only with the exchange, never directly with one another. The exchange receives a payment from the purchaser in at least the amount agreed upon in the transaction (an additional transaction servicing fee may also be required to support the exchange) as indicated by arrows 60a, 60b, 60c. Likewise, the exchange makes payment to the seller in an amount up to the price agreed upon the transaction as indicated by arrows 40a, 40b, 40c. (Again, a transaction servicing fee may be required, and the seller's payment reduced accordingly.) To complete the transaction the inventory being sold must be delivered from the seller 32a, 32b or 32c to the exchange 30, as indicated by arrows 58a, 58b, 58c, and from the exchange to the purchaser 34a, 34b or 34c as indicated by arrows 46a, 46b, 46c.

As will be described more fully below, an embodiment of an exchange according to the present invention is completely electronic. PSLs, event tickets, and contingent event ticket certificates along with ownership records, and the records of exchange participants, and provisions for making and receiving payment are all stored on a database. In this embodiment the act of physically delivering the inventory to the exchange and from the exchange to the purchaser is not required. Nor are the steps on making and receiving payments. Instead, the ownership records of the inventory records are changed to reflect the new owner, and credit card accounts may be charged for payment and credited for sales.

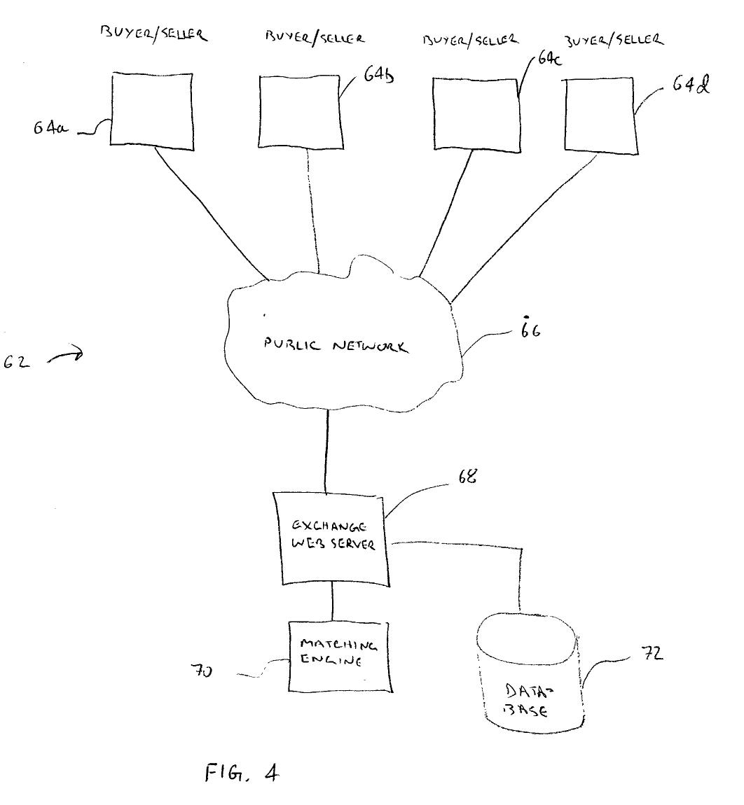

FIG. 4 shows a block diagram of a network-based exchange for trading PSLs, individual event tickets, and contingent event ticket certificates according to an embodiment of the invention. The exchange 62 includes a number of user terminals 64a, 64b, 64c . . . 64n linked to a ticket exchange web server 68 via a public network 66 such as the World Wide Web. Web server 68, in addition to being connected to public network 66 is functionally connected to exchange software 70 for matching offers and bids with indications of accepting offers and bids, and a database 72 which maintain records of PSLs, tickets and contingent event ticket certificates, who owns them, and how they are traded.

According to an embodiment of the invention only tickets associated with PSLs can be traded on the network-based exchange 56. In this embodiment the tickets associated with the PSLs are wholly creatures of the virtual exchange environment. When an individual purchases a PSL (preferably through the exchange after having registered with the exchange) a record is created in the database 72. If the PSL is not purchased through the exchange, a record of the PSL must be created and stored in the exchange database. When the licensee purchases his or her season tickets each season according to his or her rights under the PSL, the database is updated to reflect this additional inventory. Each individual ticket for each scheduled event is represented in the database and a record of its current owner (initially the PSL licensee) is also stored.

Individuals who do not own PSLs, but who are interested in purchasing tickets on the exchange must first register with the exchange. A database record is created for each registered member of the exchange. As registered customers and inventory holders make purchases and sales, their records are updated to reflect their newly acquired or depleted inventory. Furthermore, a record of each transaction is recorded each time inventory changes hands. Thus, each PSL, event ticket or contingent event ticket certificate will have a complete audit history associated with it so that each owner and each transaction can be identified at a later time. Like PSL owners, customers who have purchased inventory on the exchange may also trade their holdings. Thus, a “ticket” may change hands (virtually) several times before it is finally printed and actually used to gain access to an event.

Contingent event ticket certificates may be treated in a similar manner, or they can be distributed entirely independently of PSLs. In a first alternative, contingent event ticket certificates are created with the season ticket packages purchased by the PSL licensees each season. Thus, in the arrangement the PSL owner is the owner of record for all contingent event ticket certificates associated with the licensed seat at the beginning of each season. For example, a PSL licensee having a license to purchase season tickets for a baseball team's home games would also obtain 11 contingent event ticket certificates, three for the Divisional Playoff series games (assuming a best of 5 series), four for the League Championship series and four for the World Series, assuming a best of 7 format for the league championship series and world series. These are the maximum number of possible post season home games if the team enjoys home field advantage in each series and each series extends to the maximum number of games. Of course, the actual number of contingent events scheduled at the team's home venue may actually be much less than 11 depending on the team's performance.

Another altenative for initial distribution of contingent event ticket certificates is to offer PSL licensees a right of first refusal to purchase contingent event ticket certificates. If the PSL licensee does not exercise his or her right to purchase the corresponding contingent event ticket certificates, they may be offered for sale to the highest bidders in an on-line auction conducted on the exchange 62.

Finally, contingent event ticket certificates may be offered directly to all registered members of the exchange 62. According to this alternative, contingent event tickets are offered in an open auction. Bidding may be scheduled for a set period of time and the member offering the highest bid at the close of bidding is awarded the contingent event ticket certificate for which he or she is bidding in exchange for the winning bid price.

A note should be made here regarding the payment mechanisms for contingent event ticket certificates. Obviously, if the contingent event ticket certificates are included in the season ticket packages of PSL licensees, the PSL licensee may be charged for the contingent event ticket certificates when he or she pays for his or her season tickets. The same is true if the PSL licensees are offered a right of first refusal to purchase the contingent event ticket certificates. In the open auction model, however, since members of the exchange may be required to submit a valid credit card number to join the exchange, the credit card account of the highest bidder may be automatically charged the bid amount immediately upon the close of bidding. The purchasing member's inventory record may then be updated to reflect the newly purchase contingent event ticket certificate.

A similar automatic credit card transaction can be established to take place when contingent event ticket certificates mature into actual event tickets, such as when a team becomes eligible for post season play. Typically an announcement will be made as to when post season event tickets (playoff or championship series games and the like) will go on sale. This date, or some other arbitrary date, can be established as the date on which contingent event ticket certificates for a contingent event which is subsequently scheduled mature into actual event tickets for the newly scheduled event. Whoever is the holder of a contingent event ticket certificate on the specified date is charged the face value of the newly scheduled event ticket. Likewise, the inventory record of the owner of the contingent event ticket certificate will be updated to reflect that he or she then owns an actual event ticket rather than a contingent event ticket certificate.

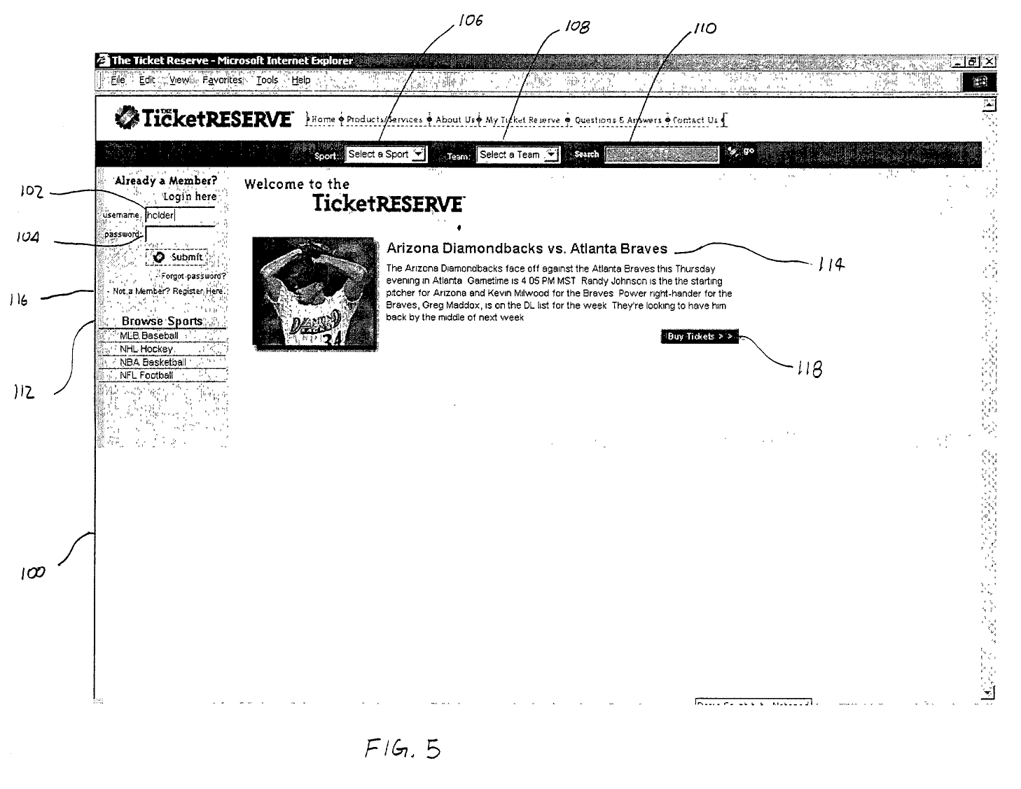

Next, referring to FIGS. 5-21 a graphical user interface for interacting with a network based electronic exchange according to the present invention will be described. The graphical user interface is a world wide web based application which is downloadable from the exchange web server 68 (see FIG. 4) as a series of web pages. The web pages forming the graphical user interface may be displayed by a conventional web browser on one ore more of the customer terminals 64a. . . 64n.

There are a number of different kinds of users who may access the network based electronic exchange. For example, PSL licensees having excess inventory they wish to sell (e.g., event tickets for events the licensee will be unable to attend), aspiring brokers and others desiring to speculate on ticket prices who are willing to purchase and sell inventory without having any intention of actually attending a particular event, and simple fans who want to get the best possible price for tickets to attend a particular event, but who are unable to purchase event tickets in the primary ticket market.

A first scenario will be described wherein a PSL licensee accesses the electronic exchange to sell excess inventory, namely tickets to an event which are associated with one or more PSLs. A next scenario will be described wherein a trader, someone who wants to buy and sell event tickets for profit, purchases the event tickets from the PSL licensee described above. Finally, a fan's purchase of the tickets offered by the broker will be described. Upon completing the transaction, the fan will print out a pair of ticket coupons for his or her own use, and send another pair of tickets to a friend. It should be noted that the parties described in the transactions below are not fixed in their roles. Fans may purchase some tickets for the purpose of attending the underlying event, or they may plan on trading some of their holdings. Brokers, in addition to buying and selling tickets may also attend some of the events and PSL holders may buy and sell additional tickets which are not associated with their PSLs, and may also actually attend events.

When a customer first accesses the exchange, a login page 100 shown in FIG. 5 is sent to the customer's computer and is displayed by the customer's web browser. The login page includes user name 102 and password 106 data entry fields for allowing the customer to log on to the exchange by entering his or her user name and password. The login page 100 may include information on one or more upcoming featured events such as an upcoming baseball game between Arizona and Atlanta as shown. A click-on option 118 to buy tickets to the featured event is also provided. In addition to the featured events 114, the user may also view information on events in different categories. For example, the customer may view different sporting events from a drop down selection menu 106. Alternatively, a customer may browse various events associated with a particular team from the select a team menu 108. A search engine search term entry field 110 is also included on the login page 100. The search engine enables the user to locate and access relevant information on a number of different events by typing in key words, such as a team name, venue, or event name into the search term data entry field 110. A browse sports function 112 is also provided. The browse sports function 112 is similar to the select a sport menu 106 assisting the customer in locating the event he or she is interested in. If the customer accessing the exchange is not a registered member of the exchange, a link 116 is provided to direct the user to a registration page where customer data may be Supplied by the customer and recorded by the exchange.

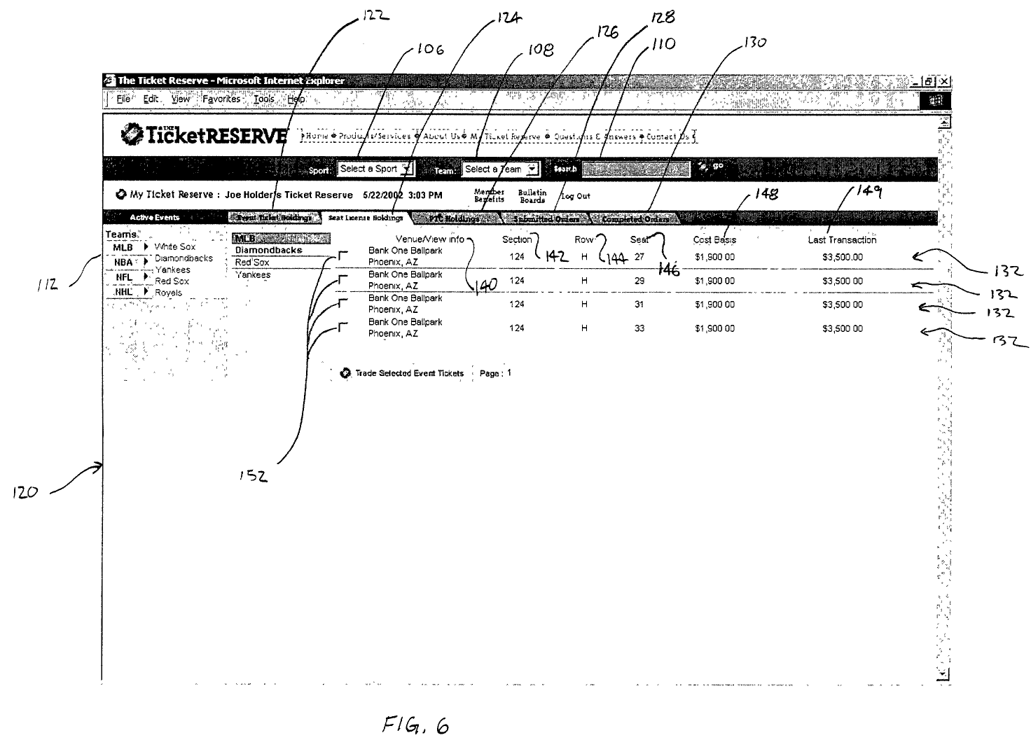

When a registered customer logs onto the exchange by entering a valid user name and password, the exchange recognizes the customer based on the user name, and presents a series of customized pages to the customer's computer reflecting the customer's holdings with the exchange. For example, according to a first scenario, a PSL licensee, Joe Holder, logs on to the exchange. A first customized user page 120 showing Joe Holder's PSL holdings is shown in FIG. 6. A number of features of the initial login page 100, such as the “sport” drop down menu 106, the “Team” drop down menu 108, and the search engine search term data entry field 110 are also displayed on the customized customer pages and are accessible throughout substantially all of the user experience. A series of selectable tabs allow the customer to view various aspects of his or her inventory. Event ticket holders tab 122 allows the customer to view his or her event ticket holdings. Seat license holding tab 124 allows the user to view his or her PSL holdings, PTC tab 126 allows the customer to view his or her contingent event ticket certificate holdings. And submitted orders tab 128 and completed orders tab 130, allow the customer to view the orders that he or she has submitted, and those which are have been completed, respectively.

FIG. 6 shows a customized customer page 120 for Joe Holder with to the seat license holdings tab 124 selected. In this example, four records 132a, 132b, 132c, 132d are shown corresponding to four PSLs owned by Joe Holder. Each record includes a description of the venue 140, the section 142, row 144, and seat number 146 of the seat associated with the corresponding PSL. The cost basis 148 for the PSL (the cost the current holder of the PSL paid for the PSL) is also displayed, as is the last transaction amount 149 paid for the most recent PSL sold in the same zone as the subject PSL. Each PSL record further includes a check box 152 for selecting the corresponding PSL record to include in a transaction. PSLs and the individual event tickets associated with PSLs may be traded in the same manner. However, because individual event tickets will be traded more often than PSLs, a full description of event ticket trading will be given below, but a description of PSL trading will be omitted.

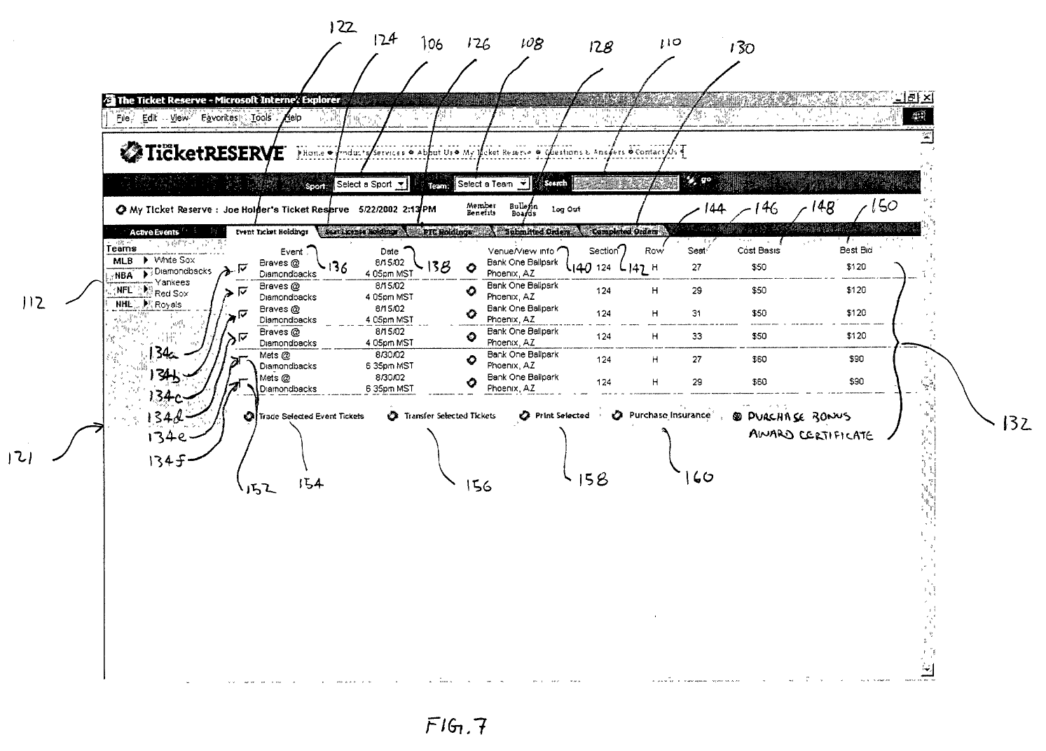

FIG. 7 shows a user customer page 121 for PSL licensee Joe Holder with the event ticket holdings tab 122 selected. This tab shows a listing 132 of event ticket records 134a, 134b, 143c, 134d, 134e, 134f. Each event ticket record includes an event description 136, the event date and time 138, the venue 140, the section row and seat numbers 142, 144, 146, the cost basis of the ticket 148 (the price paid for the ticket by the current owner), and the current best bid 150 for a ticket for a seat located in the same zone as the seat associated with the ticket. Additional pages may be provided to show the customer's additional holdings. Check boxes 152 are provided adjacent each record to allow the customer to select individual tickets for trading or other purposes. The event ticket holdings page 121 also provides click-on customer options such as Trade Selected Event Tickets 154, Transfer Selected Tickets 156, Print Selected Ticket 158, and Purchase Ticket Insurance 160.

If the ticket holder, Joe Holder, wishes to sell certain of his ticket holdings, he selects the corresponding ticket record 134 by mouse clicking the check box adjacent the ticket description. A check mark appears in the selected boxes as shown. In this example, PSL licensee, Joe Holder, has selected four tickets for the Braves v. Diamondbacks game on Aug. 15, 2002 at 4:05 MST at Bank One Ballpark. The tickets correspond to section 124, Row H, Seats, 27, 29, 31, and 33. The ticket holder then selects the “Trade Selected Event Tickets” option 154, in order to offer the selected tickets for sale.

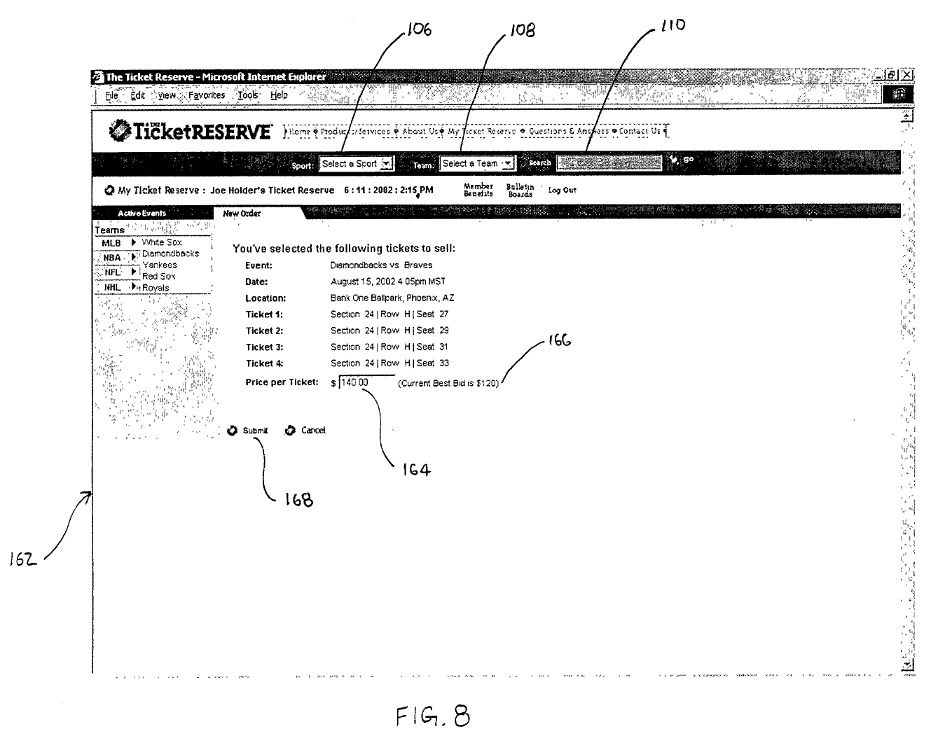

Mouse clicking on the “trade selected event tickets” option 154 causes a new order page 162 to be displayed on the customer terminal, as shown in FIG. 8. As can be seen, the new order page displays the event, the date, and location of the event, as well as the section, row and seat number designation of the tickets to be offered for sale. The new order page also includes a “Price per Ticket” field 164 where the ticket holder may enter the price at which he or she is offering to sell the subject tickets. In the example shown, Joe Holder, has entered $140.00 as the sale price for the selected tickets. A current best bid field 166 displays the current best bid that has been made for tickets located in the same zone as the tickets being offered by Joe Holder. This gives the ticket holder a sense of the market value of the tickets he or she is offering for sale. In this case, the best bid is $120.00 per ticket. Thus, Joe Holder is offering his tickets at $20.00 above the current market price. The ticket holder submits the sell tickets order by mouse clicking on the Submit option 168.

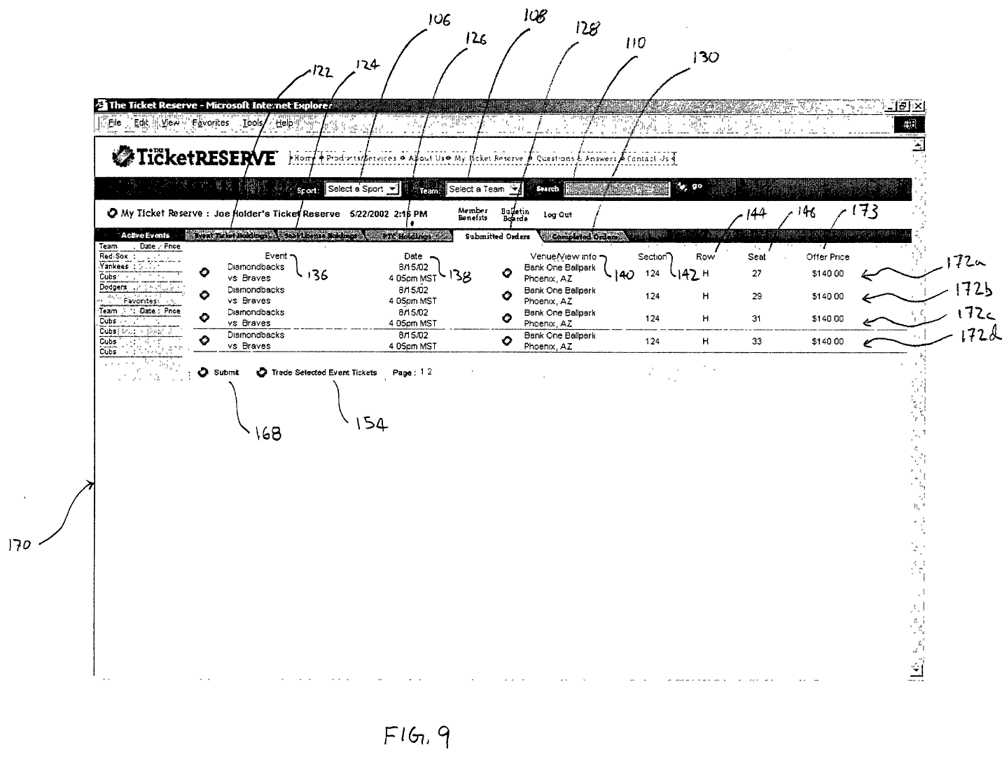

Upon submission of the sell order, the graphical user interface returns to the customized user page showing the user's ticket holdings. The ticket holder may then view the submitted order by selecting the “Customer Submitted Orders” tab 128. The data displayed under the “submitted orders” tab 128 is shown at 170 in FIG. 9. II keeping with the present example, ticket records 172a, 172b, 172c, 172d corresponding to the ticket records 134a, 134b, 132c, 134d selected for sale by Joe Holder in FIG. 7 are displayed. The ticket records 172a, 172b, 173c, 172d are substantially similar to records 134a, 134b, 134c, 134d including the event 136, date 138, venue 14, section 142, row 144, and seat number 146, but rather than including the cost basis 148 and best bid 150, the submitted orders records include the price 173 which the ticket holder entered when he or she submitted the offer, in this case. $50.00.

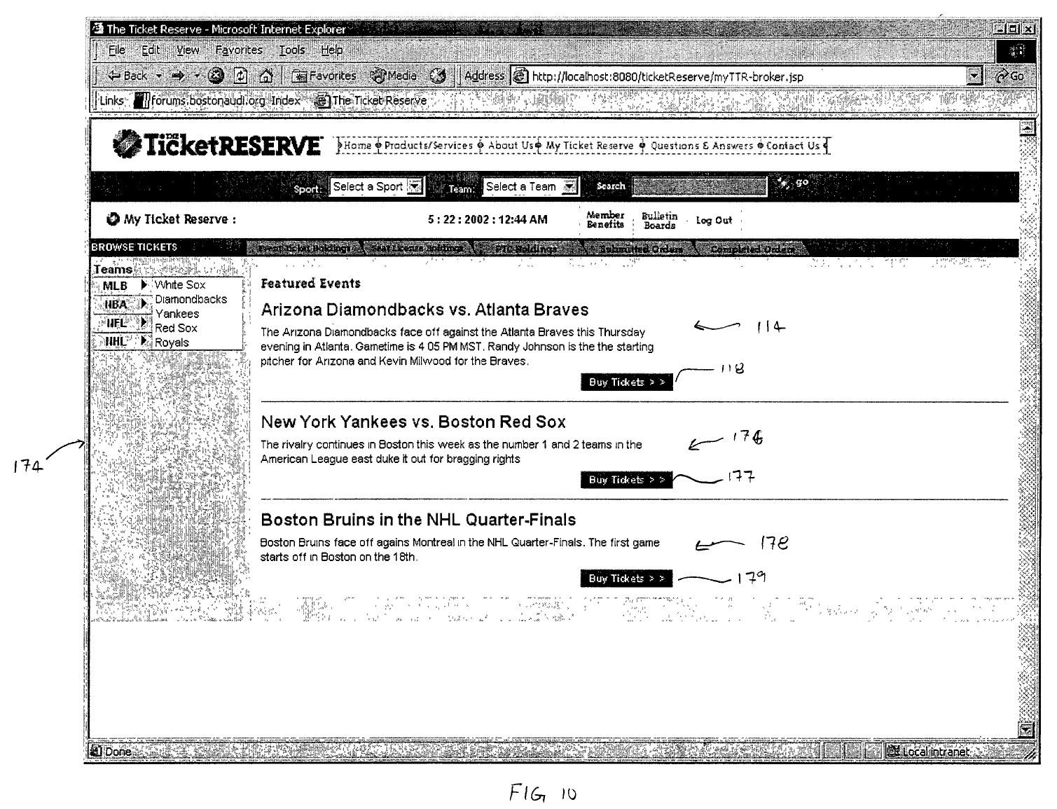

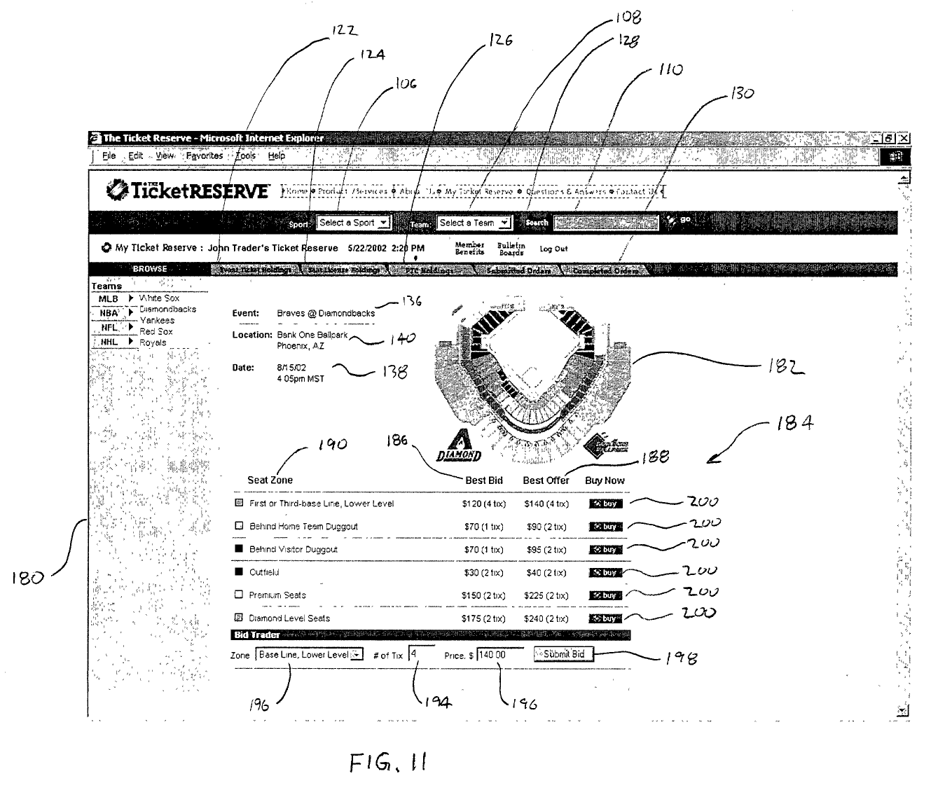

Next, a scenario will be described wherein a customer, John Trader, logs on to the exchange. In this scenario, John Trader holds no PSLs, tickets, or contingent event ticket certificates when he logs on. John Trader's intent is to purchase inventory for one or more popular events in the hope that ticket prices will increase, and that he will be able to re-sell the inventory at a profit. John Trader logs on to the exchange from the login screen 100 of FIG. 5, in the same manner as the PSL licensee in the previous scenario. However, since John Trader has no current ticket holdings, the customized holdings page 174 displayed by his browser and shown in FIG. 10 merely includes additional featured events 176, 178 in addition to the featured event 114 which was also shown on the login page 100. By selecting one of the corresponding Buy Tickets options 118, 177, 179 the customer, John Trader, can access a Purchase Event Ticket screen 180 such as that shown in FIG. 11.

The purchase event tickets screen 180 of FIG. 11 corresponds to customer John Trader selecting the buy tickets option 118 associated with the Arizona Diamond Backs v. the Atlanta Braves featured event 114. Of course, any customer, including John Trader, may arrive at the same screen (or other purchase event ticket screens for other events) by using the browsing function 112 or other navigational tools 106, 108, 110 for locating a particular event.

The purchase event tickets screen 180 lists the event 136, the venue 140 and the date 138. The purchase event tickets screen 180 also includes a map of the venue 182 illustrating the various zones for which tickets are available. A current market conditions table 184 is also displayed. The current market conditions table 184 lists the best bid 186 and best offer 188 for tickets in each seat zone 190 for which tickets are available. The customer can bid on tickets from this page by selecting a zone from a zone drop down selection menu 192, entering the number of tickets he or she wishes to purchase in a number of tickets field 194, entering a bid price in a price field 196, and selecting a submit bid option 198. The customer's bid will subsequently be displayed when other customers view the purchase/sell tickets pages as will be described below. Alternatively, the customer can elect to purchase tickets directly at the current best offer price by selecting the buy option 200 of the desired zone.

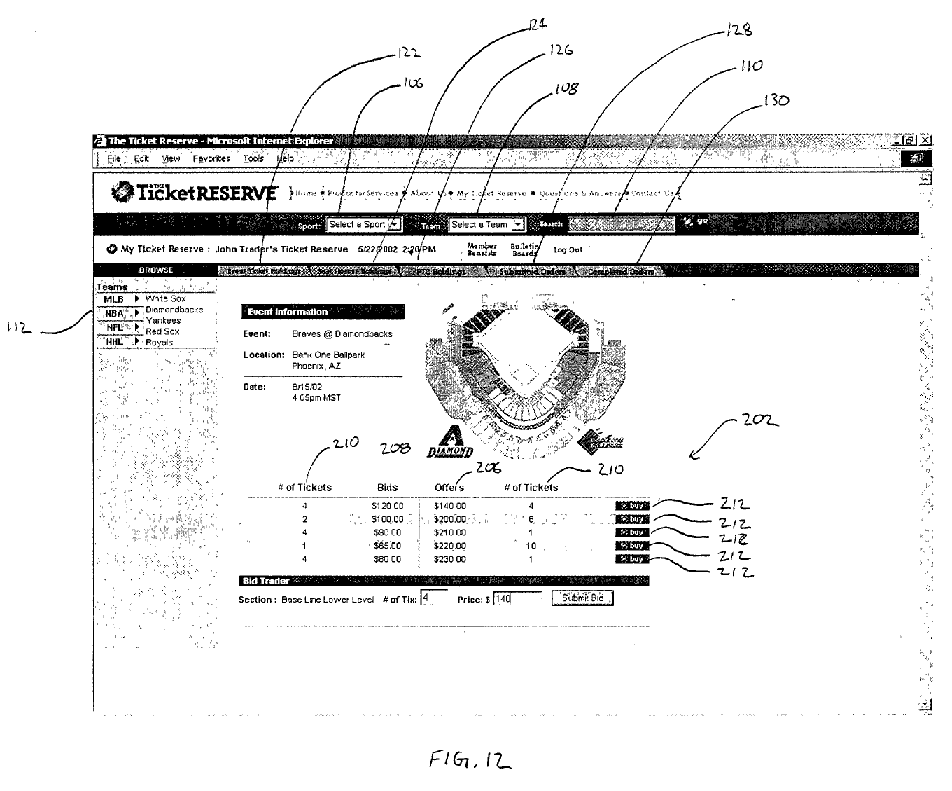

Selecting the buy option 200 adjacent one of the zone entries in the current market conditions table 184 causes a more detailed current market table 202 for the selected zone to be displayed as shown in FIG. 12. The detailed current market table 202 lists all of the offers 206 and bids 208 that have been submitted for tickets in the selected zone for the given event. The number of tickets 210 associated with each bid and each offer is also displayed. The detailed current market table 202 may be all inclusive showing all bids and offers submitted for the respective zone, or it may be limited to a smaller more manageable number of entries. Alternatively, a scroll function may be provided to display additional entries.

In the example shown in FIG. 12 five separate bids and five separate offers are displayed. From this page the customer may again submit a below market bid by entering the number of tickets in the “# of tickets” data field 194 and the price he or she is willing to pay in the “Price” data field 196. The customer submits the bid by selecting the “Submit Bid” option 198. Alternatively, the customer may purchase any of the available tickets by directly accepting a posted offer by selecting the corresponding buy option 212 adjacent the desired offer.

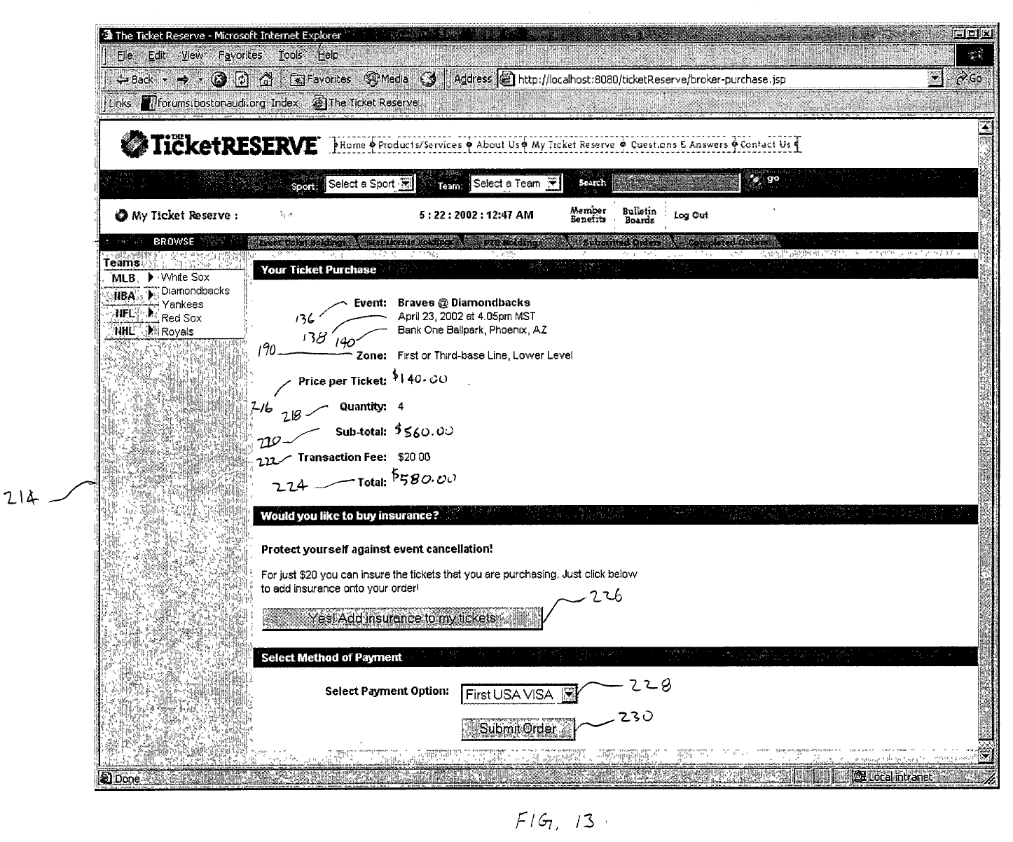

Selecting one of the buy options 212 causes an invoice page 214 to be displayed on the customer's terminal, as shown in FIG. 13. The invoice page 214 displays the event 136, the date 138 and the venue 140, the zone 190 in which the tickets are located, the price paid per ticket 216, the number of tickets 218, the subtotal of the purchase amount 220, a transaction fee amount 222 which may be added by the exchange, and a total amount 224.

The invoice shown in FIG. 13 further provides an option to purchase ticket insurance 226. Ticket insurance is a mechanism that allows the ticket purchaser to insure the price paid for the tickets in the event that the event is cancelled or rescheduled at a time inconvenient for the ticket purchaser. Typically, if the event sponsor cancels an event the event sponsor will only reimburse the face value of the tickets. However, a customer purchasing tickets for a high demand event on the exchange may pay a significant premium over the face value. By purchasing ticket insurance the customer can recoup the full purchase price paid for the tickets if the tickets become worthless or lose their value due to cancellation, rescheduling or the like. Another feature which may be offered to customers of the exchange is a bonus award program based on occurrences that take place at the event. For example, if the event is a baseball game, a customer could purchase a No Hitter Certificate. If a pitcher throws a no hitter in the designated game, the ticket holder who purchased the No Hitter Certificate would then win a prize.

Finally, the invoice page 214 includes a payment option drop down menu 228. The options available on the payment drop down menu will correspond with the payment data supplied by the customer when the customer registered with the exchange. Once the customer has selected a payment option such as Visa or Mastercard or the like, from drop down menu 228 he or she may submit the order by selecting the Submit Order option 230. At this point the customer's credit card account is billed the amount total 224 displayed on the invoice 214 at the same time the ownership records of a number of tickets equal to the quantity 218 and within the zone 190 listed on the invoice 214 are updated to reflect the new owner.

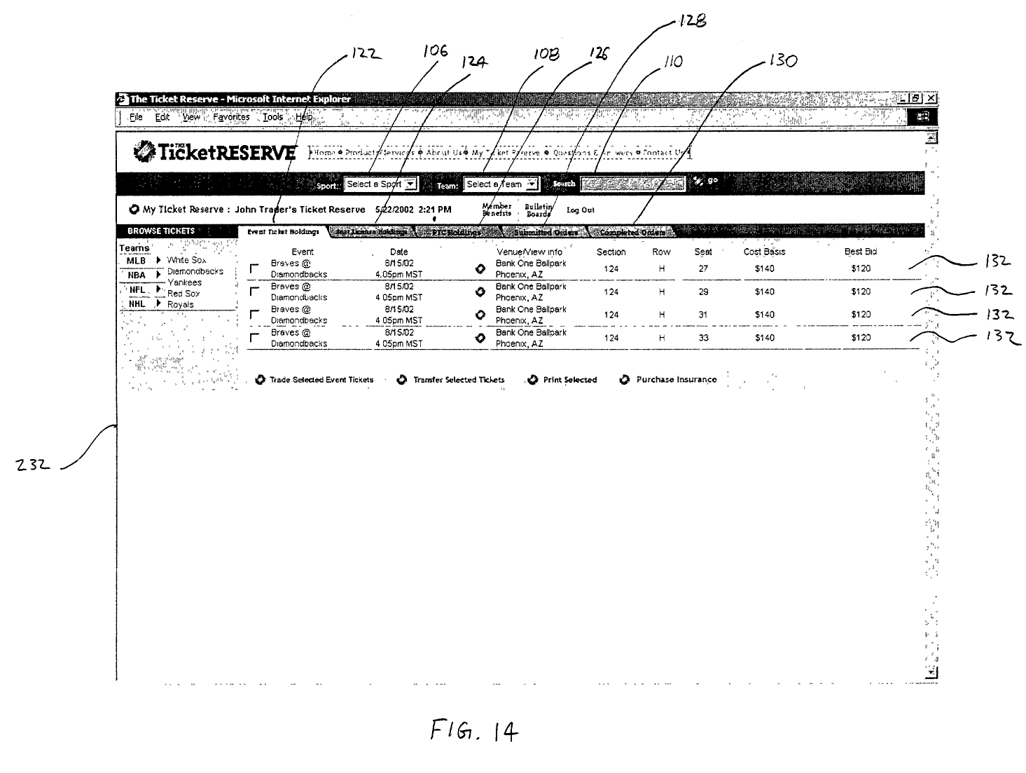

Returning to the example where John Trader is purchasing tickets on the exchange for later re-sale, we will assume that John Trader purchased the four tickets along the first third or third baseline for the Aug. 15, 2002 baseball game between the Arizona Diamondbacks and the Atlanta Braves described in the transaction above. John Trader now has inventory. Upon submitting the above order, the exchange's graphical user interface displays John Trader's customized holding page 232 shown in FIG. 14. The four newly purchased tickets are displayed under the event ticket holding tab 122. It will be noted, John Trader's newly acquired ticket holdings are the same tickets which were offered for sale by Joe Holder in the earlier example. Thus, John Holder's sell order is now complete. Although not shown, Joe Holder's customer page would no longer display these four tickets under the my holdings tab 122 and a record of the transaction would be displayed under the completed transactions tab 130.

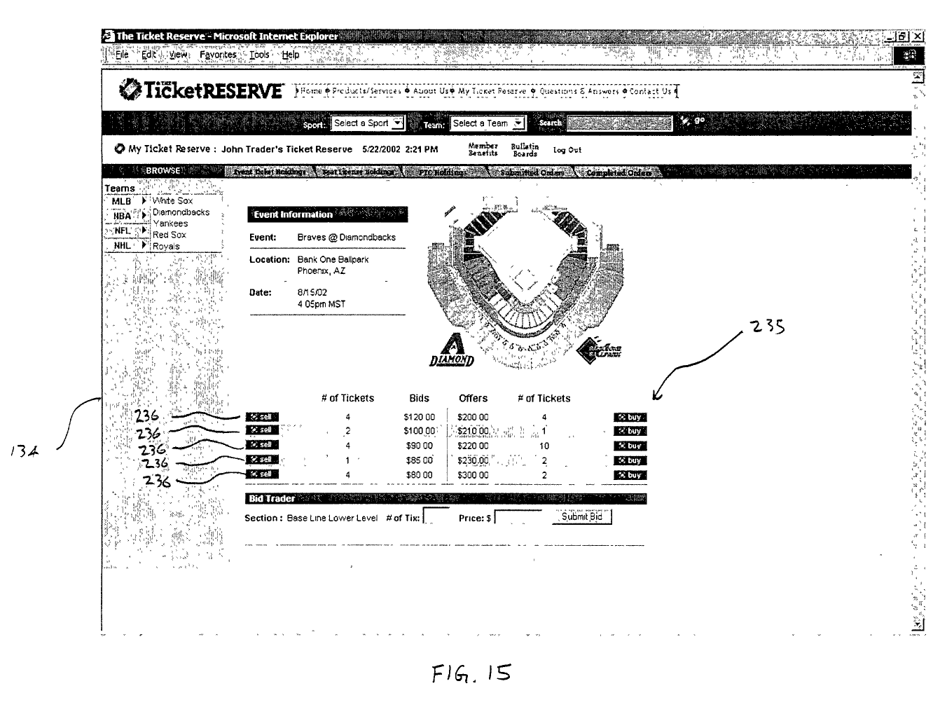

Now that John Trader has inventory, he can turn around and sell the event tickets that he has purchased. John Trader can offer to sell the tickets above the current market price or he can accept a bid from another customer on the exchange. The steps necessary for John Trader to place an above market offer to sell are identical to those described above with regard to Joe Holder's offer to sell his inventory and will not be repeated here. Alternatively, the steps necessary for John Trader to accept a current bid posted by another potential buyer will be described. It should be noted that Joe Holder also could have sold his tickets according to this alternate method. Suppose that Jane Fan has submitted a bid for four tickets to the Aug. 15, 2002, Arizona Diamondbacks v. Atlanta Braves baseball game at Bank One Ballpark, and that she has bid $200 per ticket. John Trader can monitor the market price for his inventory by locating the event or events for which he holds tickets using the navigational tools 106, 108, 110, 112. In the example, John Trader may again locate the Diamondback v. Braves game to display the detailed purchase/sell event tickets screen 234 shown in FIG. 15. The detailed purchase/sell event tickets screen 234 is substantially identical to the detailed purchase tickets screen 201 of FIG. 12, except that the desired zone current market table 235 includes selectable sell options 235adjacent the current bids. These appear because John Trader now has the appropriate inventory to sell.

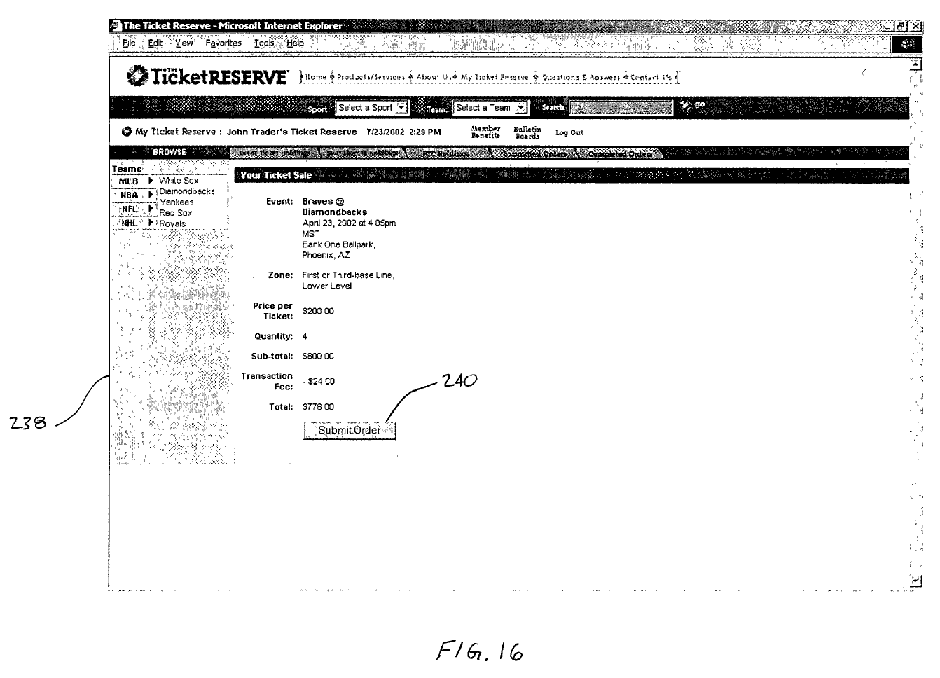

Jane Fan's bid for 4 tickets at $200.00 is currently the best bid. John Trader may accept this bid by selecting the sell option 236 adjacent Jane Fan's bid. Of course, John Holder has no idea of the identity of the party who has submitted the bid. Selecting sell option 236 causes a sales invoice screen 238 to be displayed by John Trader's browser as shown in FIG. 16. Again, the invoice includes the event 136, the date 138, the venue 140, the seating zone 190, the price per ticket 216, the number of tickets 218, a subtotal amount 220, transaction fee 222, and a total amount 224. In this case, the transaction fee is subtracted from the subtotal and the total amount 224 is credited to John Trader's credit card account upon his selecting the submit order option 240.

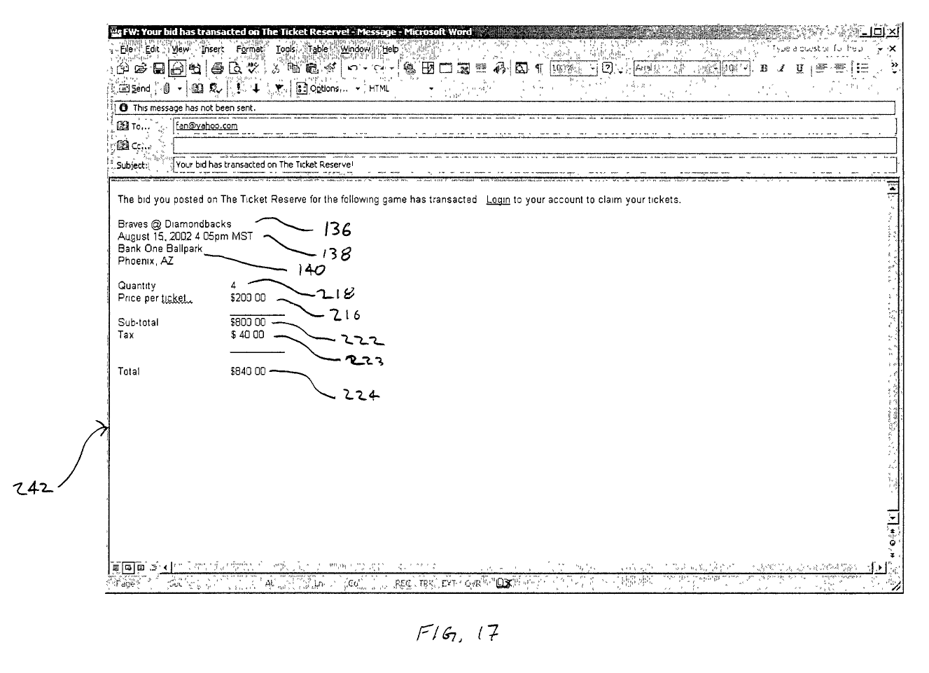

On the purchaser's side, Jane Fan's bid having been accepted, the purchase transaction proceeds automatically. The exchange sends a message to Jane Fan according her preferred method of communication, (determined when she registered with the exchange.) For example, the exchange may send an e-mail message 242 as shown in FIG. 17. The message indicates the event 136, the date 138, the venue 140, the price for ticket 216, the quantity 218, the subtotal 222, sales tax 223 and total 224. The total amount is automatically charged to Jane Fan's credit card, and the ownership records of the four tickets are updated to reflect the new owner.

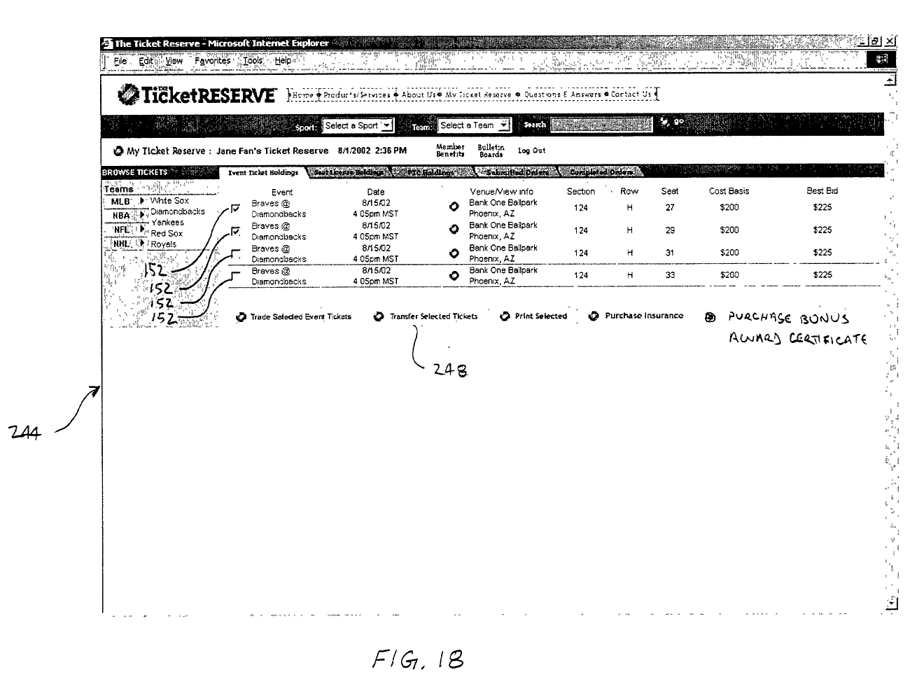

Upon receiving the message 242 Jane Fan may log onto the exchange to view her ticket holdings by accessing her customized user page 244. Her new ticket holdings are displayed under the event ticket holdings tab 122 shown in FIG. 18. As can be seen, Jane Fan's ticket holdings now include the four tickets for the Apr. 23, 2002 Braves-Diamondbacks game at Bank One Ballpark. Since Ms. Fan paid $200.00 per ticket the cost basis is displayed is $200.00. Although not shown, John Trader's ticket holdings at this point would be empty, as he has sold his entire inventory. When viewing her holdings from her customized ticket holdings page 244 Jane Fan can elect to purchase insurance for one or more of her tickets by selecting the check box 152 adjacent to the desired ticket and selecting the purchase insurance option 246. Additional screens (not shown) are provided for transacting a ticket insurance purchase.

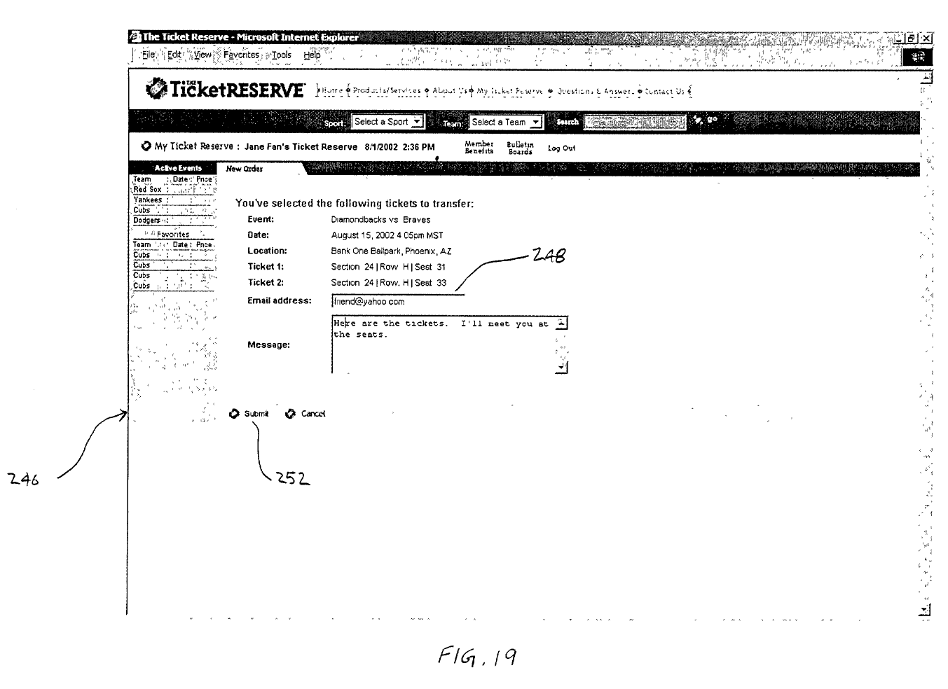

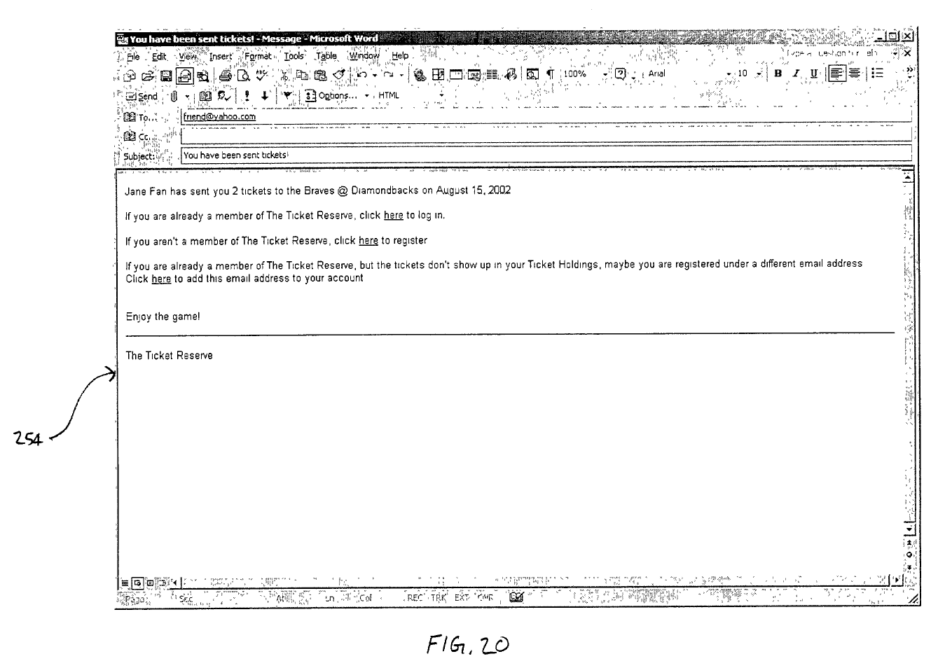

Of course, Jane Fan, having inventory can offer her ticket for sale, accept a bid for the tickets, or actually use the tickets. She may also electronically transfer some or all of her tickets to a friend. To transfer tickets she selects the check box 152 adjacent to the appropriate tickets as shown in FIG. 18, then selects the transfer tickets option 248. This causes the ticket transfer page 246 shown in FIG. 19 to be displayed by Jane Fan's web browser. The ticket transfer page includes the description of the selected tickets, including the event 138, the date 140, the venue 142 and the section row and seat number 144, 146, 148. The transfer ticket page also includes a data field 248 for entering the transferee's e-mail address, as well as a text field 250 for entering a message. Upon selecting the Submit option 252 an e-mail message 254 such as that shown in FIG. 20 is sent to the address entered in the e-mail address field 248. If the transferee is registered with the exchange he or she may login to the exchange to view the transferred tickets and print ticket coupons if he or she intends to use them. If the transferee is not registered with the exchange, he or she must register before being allowed to view and print the transferred tickets.

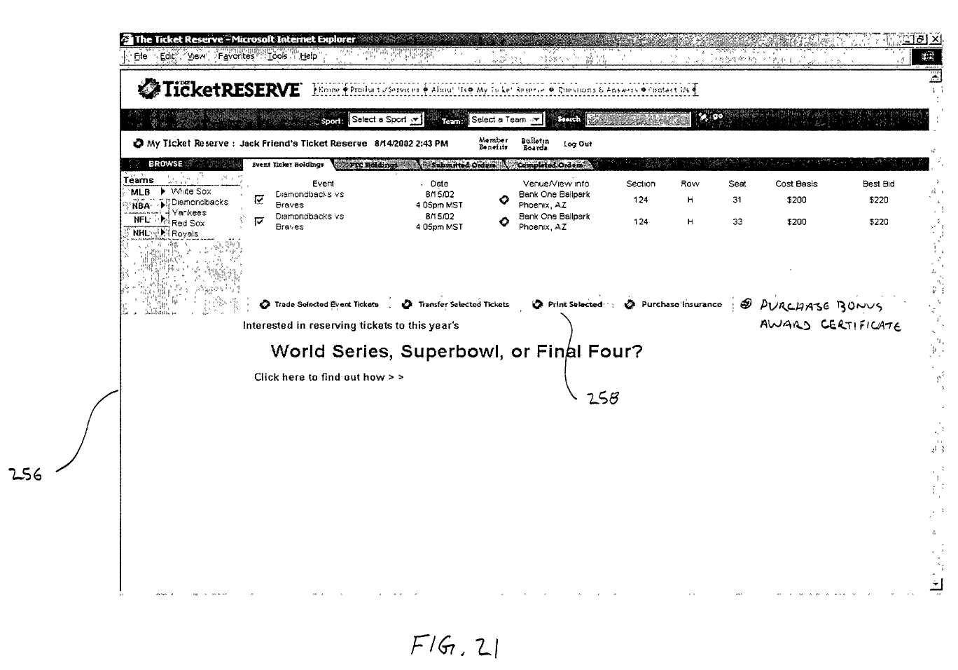

In the example shown, Jane Fan transferred two of her tickets to the Aug. 15, 2002 Braves-Diamondbacks game to her friend, Jack Friend. The transferred tickets correspond to seats 31 and 34, row H, section 124 at Bank One Ballpark. These tickets now appear under the event tickets holdings tab 122 of Jack Friend's customized ticket holdings page 256, as shown in FIG. 21. To use the tickets Jack Friend selects the check boxes 152 adjacent the tickets and selects the print selected option 558. Jack Friend's computer then causes ticket coupons 260 shown in FIG. 21 to be printed. Significantly, the ticket coupons 260 identify Jack Friend as the ticket holder and include bar codes 262 the bar codes may include coded data that ensures that the ticket is authentic. The ticket coupons identify the event 138, the date 140, the section number 144, row 146 had seat number 148 in the same manner as any conventional ticket. Of course, Jane Fan can print her ticket holdings in the same maimer, as can any other event ticket holder.

Finally, it should be noted that contingent event certificates, can be traded on the exchange in the same manner as event tickets. With the graphical user interface just described. An exchange member's contingent event ticket certificates are referred to as playoff ticket certificates and may be viewed from the PTC holdings tab 126 of a customer's customized holdings page. Once the contingent event ticket certificates mature into actual event tickets, the records are removed from the customer's PTC holdings tab 126 and are displayed on the event ticket holdings tab 124.

Thus, the present invention provides an electronic exchange for and a method of trading permanent seat licenses, event tickets and contingent event ticket certificates. It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. An exchange for trading event tickets comprising:
means for listing offers to sell event tickets;
means for listing bids to purchase event tickets;
means for receiving indication of acceptance of at least one of said bids and offers;
a matching engine for matching said indication of the acceptance of at least one of said bids and offers with the accepted bid or offer;
whereby at least one event ticket is traded according to the accepted bid or offer.

2. The exchange of claim 1 wherein said means for listing offers to sell and said means for listing bids to purchase event tickets further provide for the listing of offers to sell and bids to purchase seat licenses.

3. The exchange of claim 1 wherein said means for listing offers to sell and said means for listing bids to purchase event tickets further provide for the listing of offers to sell and bids to purchase contingent event ticket certificates.

4. The exchange of claim 1 wherein said means for listing offers to sell and said means for listing bids to purchase event tickets further provide for the listing of offers to sell and bids to purchase seat licenses and contingent event ticket certificates.

5. The exchange of claim 4 further comprising means for tracking and recording transactions occurring on said exchange.

6. The exchange of claim 5 wherein the means for tracking and recording transactions includes recording data relating to the buyers and sellers of seat licenses, tickets, and contingent tickets traded on said exchange.

7. The exchange of claim 1 which further includes means for purchasing insurance for seat licenses, tickets and contingent tickets purchased on the exchange.

8. The exchange of claim 1 which further includes means for selling a bonus award certificate whereby a holder of a bonus award certificate may win a prize based on the occurrence or non-occurrence of a specified circumstance at said event.

9. A network based exchange for trading event tickets comprising:
a web server accessible by a plurality of buyers and sellers over a network, the web server adapted to provide an exchange interface to said buyers and sellers to be displayed on corresponding buyer and seller terminals, the interface being configured to transmit input commands from the buyers and sellers to the web server for submitting offers to sell tickets, bids to purchase tickets, and commands to accept selected offers to sell and bids to purchase tickets;
a database for maintaining a record of said buyers and sellers, said tickets, ownership of said tickets, and said bids to purchase and offers to sell said tickets; and
a matching engine for matching said commands to accept offers to sell and bids to purchase event tickets with the corresponding offers to sell and bids to purchase event ticket, and executing transaction to exchange event tickets between first buyers or sellers who submitted the offers to sell or bids to purchase event tickets and second buyers or sellers who issued the commands to accept the offers to sell and bids to purchase event tickets.

10. The exchange of claim 9 wherein the matching engine is adapted to update the database to reflect the change in ownership of said tickets based on said transactions.

11. The exchange of claim 9 wherein said web server is further adapted to execute a credit card transaction to charge a ticket purchaser's credit card account an amount corresponding to a bid to purchase a ticket made by the purchaser which was accepted by a seller or corresponding to an offer to sell a ticket made by a seller which was accepted by the purchaser.

12. The exchange of claim 9 wherein said web server is further adapted to executed a credit card transaction to credit a ticket seller's credit card account in an amount corresponding an offer to sell a ticket made by said seller and which was accepted by a purchaser, or in an amount corresponding to a bid to purchase a ticket made by a purchaser, and accepted by said seller.

13. The exchange of claim 9 wherein said web server is further adapted to receive bids to purchase, offer to sell and commands to accept said bids to purchase and offers to sell seat licenses, and said database is configured to maintain a record of said seat licenses, ownership of said seat licenses and said bids to purchase and offers to sell said seat licenses, and wherein said matching engine is configured to match said commands to accept offers to sell and bids to purchase with the corresponding offers to sell and bids to purchase event tickets.

14. The exchange of claim 9 wherein said web server is further adapted to receive bids to purchase, offer to sell and commands to accept said bids to purchase and offers to sell contingent event ticket certificates, and said database is configured to maintain a record of said contingent event ticket certificates, ownership of said contingent event ticket certificates and said bids to purchase and offers to sell said contingent event ticket certificates, and wherein said matching engine is configured to match said commands to accept offers to sell and bids to purchase with the corresponding offers to sell and bids to purchase contingent event ticket certificates.

15. The exchange of claim 9 wherein said interface is adapted to display the best bid to purchase an event ticket submitted by a purchaser on said buyers' and sellers' terminals.

16. The exchange of claim 9 wherein said interface is adapted to display the best offer to sell an event ticket submitted by a purchaser on said buyers' and sellers'=0 terminals.

17. The exchange of claim 12 wherein said interface is adapted to display the best bid to purchase an event ticket submitted by a purchaser on said buyers' and sellers' terminals.

18. The exchange of claim 12 wherein said interface is adapted to display the best offer to sell an event ticket submitted by a purchaser on said buyers' and sellers' terminals.

19. The exchange of claim 13 wherein said interface is adapted to display the best bid to purchase an event ticket submitted by a purchaser on said buyers' and sellers' terminals.

20. The exchange of claim 13 wherein said interface is adapted to display the best offer to sell an event ticket submitted by a purchaser on said buyers' and sellers' terminals.

21. A method for trading seat licenses, each seat license associated with a designated seat in a venue, and event tickets associated with said seat licenses for predefined events scheduled to take place in said venue, the method comprising the steps of:
receiving offers to sell said licenses, and event tickets, said offers to sell including an asking price;
receiving offers to purchase said licenses and event tickets, said offers to purchase including a bid price;
receiving indications of acceptance of said offers to sell and bids to purchase;
matching indications of accepting particular offers to sell with the corresponding offers to sell and matching indications of accepting particular bids to purchase with the corresponding bids to purchase; and
communicating said offers to sell and bids to purchase to a plurality of potential buyers and sellers;
exchanging licenses and event tickets between sellers and buyers in accordance with said accepted offers to sell and bids to purchase.

22. The method of trading of claim 21 further including the step of charging said buyers an amount corresponding to a corresponding accepted offer to sell or bid to purchase, and crediting a purchaser an amount corresponding to an accepted offer to sell or bid to purchase.

23. The method of trading seat licenses and event tickets of claim 22, further including trading contingent event certificates said method of further comprising:
establishing a conversion date on which contingent event ticket certificates will convert, if they convert all, into event tickets;
determining a contingent event ticket certificate holder as of said conversion date;
charging said contingent event ticket certificate holder an amount equal to a face value of a contingent event ticket on said conversion date; and
converting said contingent event certificate into an event ticket.

24. The method of claim 21 further comprising the step of granting said seat licenses to licensees, said seat licenses granting each licensee a right to purchase tickets for a designated seat at a plurality of predefined events scheduled to be held in said venue on a periodic basis.

25. The method of claim 24 wherein said seat licenses confer an obligation to purchase said tickets for said designated seat at said plurality of events scheduled to be held in said venue on a periodic basis.

26. The method of claim 21 wherein said seat licenses further grant to each licensee a right to purchase a contingent ticket for at least one future event that may or may not be scheduled to be held in said venue, if said future event is in fact scheduled.

27. The method of claim 26 wherein said seat licenses confer an obligation to purchase said contingent ticket if said future event is scheduled.

28. The method of claim 24 wherein said seat licenses further grant to each licensee a right of first refusal to purchase a contingent ticket for at least one future event that may or may not be scheduled to be held in said venue, if said future event is in fact scheduled.

29. The method of claim 21 further comprising the step of tracking and recording transactions.

30. The method of claim 29 wherein the step of tracking and recording transactions further includes recording data relating to the buyers and sellers of seat licenses, tickets, and contingent tickets traded on said exchange.

31. The method of claim 21 further comprising the step of providing insurance to event tickets purchasers to project an amount paid for event tickets in case the event is rescheduled or cancelled.

32. The method of claim 21 further comprising the step of offering to sell a bonus award certificate whereby a holder of a bonus award certificate may win a prize based on the occurrence or non-occurrence of a specified circumstance at the event.

33. A method for trading rights and obligations associated with a seat license, the method comprising of:
establishing a season ticket package which includes a plurality of event tickets, each event ticket corresponding to one of a plurality of events scheduled to take place at a venue and corresponding to a designated seat within said venue;
establishing a seat license granting a licensee the right to purchase the season ticket;
issuing the seat license to a licensee;
receiving an offer to sell said seat license, said season ticket package or an event ticket;
receiving an offer to purchase at least one of said seat license, said season ticket package, and said event tickets;
receiving an acceptance of an offer to sell said seat license, season ticket packages or event ticket or an acceptance of a bid to purchase said seat license season ticket package or event ticket.
exchanging at least one of said seat license, season ticket package and event ticket between a seller and a purchaser corresponding to said accepted offer to sell or bid to purchase.

34. The method of claim 33 wherein said seat license confers an obligation to purchase said season ticket package.

35. The method of claim 33 wherein said seat license further grants to the licensee a right to purchase a contingent event ticket certificate for at least one future event that may or may not be scheduled to be held in said venue.

36. The method of claim 35 wherein said seat license confers an obligation to purchase said contingent event ticket certificate if said future event is scheduled.

37. The method of claim 33 wherein said seat license further grants to the licensee a right of first refusal to purchase a contingent event ticket certificate for at least one future event that may or may not be scheduled to be held in said venue.

38. The method of claim 33 further comprising the step of tracking and recording transactions between buyers and sellers.

39. The method of claim 38 wherein the step of tracking and recording transactions further includes recording data relating to the buyers and sellers.

40. The method of claim 33 further comprising the step of enabling the buyers and sellers to purchase insurance for said seat licenses, season tickets and event tickets.

41. The method of claim 21 further comprising the step of offering to sell a bonus award certificate whereby a holder of a bonus award certificate may win a prize based on the occurrence or non-occurrence of a specified circumstance at the event.

42. The method of claim 33 further comprising the step of auctioning contingent event ticket certificates.

43. A method of distributing event tickets for a contingent event which may or may not in the future be scheduled, the method comprising the steps of:
issuing a contingent event ticket certificate for the event;
converting the contingent event ticket certificate into a ticket for the event if the event is in fact scheduled; and
charging a holder of the contingent event ticket certificate a predetermined amount at a time associated with the scheduling of the contingent event.
